(19) United States
(12) Patent Application Publication
(10) Pub. No.: US 2013/0196038 A1
(43) Pub. Date: Aug. 1, 2013

(54) METHOD AND APPARATUS OF PROGRAMMABLE TEMPERATURE CONTROLLER WITH DUAL PROBES FOR COOKING AND SMOKING OF FOOD

(71) Applicant: Suyi Liu, Alpharetta, GA (US)

(72) Inventor: Suyi Liu, Alpharetta, GA (US)

(73) Assignee: AUBER INSTRUMENTS INC., Alpharetta, GA (US)

(21) Appl. No.: 13/362,933

(22) Filed: Jan. 31, 2012

(51) Int. Cl. A47J 36/00; A23L 1/01

(52) U.S. Cl. 426/233; 99/329 R; 99/328

(57) ABSTRACT

A programmable temperature controller with dual temperature probes for food cooking, comprising: (a) an AC power supply for providing power supply to the programmable temperature controller, a smoker cooker, and a smoke generator, (b) a plurality of temperature probe inputs, (c) a smoker cooker power supply, (d) a smoker cooker cooling fan power supply, (e) a smoke generator control, (f) a plurality of user input keys, and (g) a plurality of information displays, wherein the cooking is divided into several phases and these phases can be terminated by either a predetermined cooking time or a predetermined food internal temperature, and the user uses the plurality of user input keys to program the programmable temperature controller, the programmable temperature controller controls the smoker cooker, and the smoke generator according to the plurality of the temperature probe inputs and cooking duration programmed into the programmable temperature controller to obtain optimal cooking results.

### FIELD OF THE PRESENT INVENTION

The present invention relates to a method and an apparatus of precise temperature control of cooking devices, and more particularly to a programmable temperature controller with dual temperature probes for cooking and smoking of food.

### BACKGROUND OF THE PRESENT INVENTION

Preserving meat by smoke from hardwood or fruit tree wood chips has a long history dating back thousands of years. Although many other modern technologies are used to preserve meat, smoking meat is still very popular due to its distinct flavor. Modern smoking process is usually accomplished by using a smoker oven, which may include a smoker chamber that can be heated, a smoke generator and other accessories such as cooling shower or cooling fan. The smoker chamber is similar to a regular baking oven heated by electric heater, gas burner, burning charcoal or coal. The smoke generator burns hardwood or fruit tree wood chips at low temperature to generate ample amount of smoke. The smoke generator can be ignited by a electric burner or have self regulated burning mechanism. The smoke is introduced from the smoke generator to the smoke chamber by an air duct.

Following is a typical example of sausage smoking process.

The first phase is to dry the sausages at approximately 140° F. Prepare a dried surface before high temperature cooking will preventing the liquid or oil from flowing out and damaging the appearance and the texture of the sausage. If the external drying temperature is controlled constantly, the internal meat temperature can be used as a good indicator for the drying phase, e.g. when drying at 140° F., the sausage is ready when internal temperature reaches 100° F.

The second phase is to smoke the sausage at 150° F. Most people prefer smoking at a relatively low temperature because the smoke flavor penetrates the meat better when the meat is raw (undenatured protein) than cooked (denatured protein). Ingredients move more easily in undenatured than denatured protein. Smoking process is normally finished by length of time, not the internal temperature because it is mainly a surface treatment for the meat preservation purpose. The smoking time determines how deep the smoke will penetrate.

After smoking phase is completed, the next phase is to cook the meat. The cooking phase is normally set at a higher temperature. For thin piece of meat such as fish, controlling the smoker chamber temperature and cooking time is the common approach. However, for meat that has irregular shape and thick, it is difficult to know if the meat is ready by the cooking time. Under cooked meat may be too raw, while over cooked meat will be too dry. The best method is to monitor the internal meat temperature until it reaches the desired temperature.

Finishing phase is to cook at relative high temperature to bring the surface of the meat to the desired color and texture. It can be done either by controlling the timing at very high temperature for very short time, or by monitoring the internal temperature when longer time is needed, so that the meat does not get over cooked.

The final phase is to cool down the food quickly to avoid stay in the so-called “danger zone” temperature too long, preventing the bacterial growth. One of the cooling methods is to shower cold water over the sausage for a few minutes. Another way is to blow cold air until the sausage internal temperature drops to 100° F.

The example showed above used 5-phase cooking, Phase 1 is terminated when the food internal temperature reaches a predetermined temperature value, Phase 2 is terminated when the cooking time reaches a predetermined time value, phase 3 is terminated when the food internal temperature reaches another predetermined temperature value, and phase 4 and 5 are terminated either when the food internal temperature reaches a predetermined temperature value, or when the cooking time reaches a predetermined time value. Since there is no programmable temperature controller available to meet the requirements described, many people have to manually control the smoking process phase by phase.

As described above, smoking meat or sausage normally involves several phases of cooking, e.g drying, smoking, cooking, finishing and cooling. In order to obtain the best flavor of the smoked meat, precise temperature control is a key element. Starting temperature, ending temperature, the length of time the meat to be smoked vary among different phases and different types of meat. Another key element is how to terminate each phase. Traditionally, various phases of the most smokers currently in the market are either by (1) the length of time the meat was smoked, or (2) the internal meat temperature the meat has reached. Each of the method (1) and method (2) has its own advantages and disadvantages with regard to each of the cooking phases mentioned above.

High precision programmable temperature controllers are used in baking and smoking oven. Many of them come with program for multiple phases of cooking temperature and time. In this type of controllers, users can set the cooking temperature and cooking time for each phase. Users can determine when the meat is ready. However, there is no commercial multiple phase programmable temperature controllers that can be programmed to cook with preset time during some phases and by preset internal meat temperature in other phases. Most of industrial smoker controllers were custom made for a specific application that only run a specific temperature profile. For a commercial smoker programmable temperature controller, it has to be flexible to meet different customers' needs because each user may have his/her own recipe with its own temperature profile for cooking. The difficulty is that the controller has to be easy to use for chefs or housewives that do not have any engineering background. That may be possible for a controller with graphic user interface (GUI). But it is cost prohibitive for small operation and household use. It is difficult for commonly used precision programmable temperature controllers, that have three to four digits display and three to four keys for input, to have such flexibility and ease of use.

Therefore, a heretofore unaddressed need to take full advantages of the cooking phase termination method and overcome the disadvantages exists in the art and it is desirable to design a new precise programmable temperature controller for a cooking device that flexibly use of one of the cooking phase termination methods for different cooking phases at the operator's discretion.

### SUMMARY OF THE PRESENT INVENTION

In one aspect, the present invention relates to a programmable temperature controller with dual temperature probes for cooking and smoking of food. In one embodiment, the programmable temperature controller has: (a) an AC power supply with a switch and a fuse for providing power supply to the programmable temperature controller, a smoker cooker, and a smoke generator, (b) a plurality of temperature probe inputs, (c) a smoker cooker power supply output for providing and controlling the power supply to the smoker cooker, (d) a smoker cooker cooling fan power supply output for providing and controlling the power supply to a cooling fan for the smoker cooker, (e) a smoke generator control output for providing and controlling the power supply to the smoke generator, (f) a plurality of user input keys for a user to enter cooking control programs according to a plurality of cooking phases, (g) a plurality of information displays for displaying cooking process and progress, current temperatures, cooking durations, status of the smoker cooker and the smoke generator, and (h) a central processing unit with internal memory to store a plurality of control programs from the user, and controls the food cooking and smoking process according to the programs. The user uses the plurality of user input keys to program the programmable temperature controller, the programmable temperature controller controls the smoker cooker, and the smoke generator according to the plurality of the temperature probe inputs and cooking duration programmed into the programmable temperature controller to obtain optimal cooking results.

In one embodiment, the plurality of temperature probe inputs includes: (a) a chamber temperature probe input, and (b) a food internal temperature probe input. The smoker cooker cooling fan power supply output further includes a first relay to provide multiple phase control to the smoker cooker cooling fan. The multiple phase controls are synchronized with the cooking phases of the smoke cooker. The smoke generator control output further has a second relay to provide multiple phase control to the smoke generator power supply output. The multiple phase controls are also synchronized with the cooking phases of the smoke cooker.

In one embodiment, the plurality of information displays includes: (a) an LED Smoke Generator output indicator R indicating whether the Smoke generator is powered on (LED on) or off (LED off), (b) an LED Smoker Cooker output indicator OUT indicating whether the smoker cooker is powered on (LED on) or off (LED off), (c) a TEMP1 display window indicating the chamber temperature received from the chamber temperature probe input, and (d) a TEMP2/TIME display window indicating the food internal temperature received from the food internal temperature probe input, or the cooking time after the programmable temperature controller is powered up (cooking time) if an LED indicator TIME is lit.

In one embodiment, the plurality of user input keys includes: (a) a “SET” key for displaying current temperature settings, getting into parameter setting mode and confirming various actions taken, (b) a “−” key for decrement of displayed value when the programmable temperature controller is in parameter setting mode, and during normal operation, for cancelling any alarm when it is pressed, (c) a “+” key for increment of displayed value when the programmable temperature controller is in parameter setting mode, and during normal operation, for displaying current phase number the smoker cooker is current in when it is pressed, and (d) a “TIME” key for toggling the TEMP2/TIME display window display between the food internal temperature received from the food internal temperature probe input when the LED indicator TIME is off, and the cooking time after the programmable temperature controller is powered up (cooking time) when the LED indicator TIME is lit.

The cooking and smoking food with the smoker cooker and the smoke generator, both controlled by the programmable temperature controller with dual temperature probes accommodates following cooking phases: (a) drying, (b) smoking, (c) cooking, (d) finishing cooking, and (e) cooling. Each of these cooking phases can be terminated by following ending criteria: (a) a predetermined cooking time, or (b) a predetermined food internal temperature. The cooking process is programmed into the programmable temperature controller by the user.

In another aspect, the present invention relates to a method of cooking and smoking food with a smoker cooker and a smoke generator, both controlled by a programmable temperature controller with dual temperature probes. The method includes the steps of:
(a) providing a programmable temperature controller;
(b) programming the programmable temperature controller by using the plurality of user input keys;
(c) turning on the programmable temperature controller, the smoker cooker and the smoke generator to cook and smoke the food;
(d) monitoring the cooking and smoking process through the plurality of information displays;
(e) retrieving the food when the plurality of information displays indicate that the cooking and smoking process is completed; and
(f) turning off the programmable temperature controller, the smoker cooker and the smoke generator, when the cooking and smoking process is completed.

In one embodiment, the programmable temperature controller has: (a) an AC power supply with a switch and a fuse for providing power supply to the programmable temperature controller, a smoker cooker, and a smoke generator, (b) a plurality of temperature probe inputs, (c) a smoker cooker power supply output for providing and controlling the power supply to the smoker cooker, (d) a smoker cooker cooling fan power supply output for providing and controlling the power supply to a cooling fan for the smoker cooker, (e) a smoke generator control output for providing and controlling the power supply to the smoke generator, (f) a plurality of user input keys for a user to enter cooking control parameters according to a plurality of cooking phases, (g) a plurality of information displays for displaying cooking process and progress, current temperatures, cooking durations, status of the smoker cooker and the smoke generator, and (h) a central processing unit with internal memory to store a plurality of control programs from the user, and controls the food cooking and smoking process according to the programs. The user uses the plurality of user input keys to program the programmable temperature controller, the programmable temperature controller controls the smoker cooker, and the smoke generator according to the plurality of the temperature probe inputs and cooking duration programmed into the programmable temperature controller to obtain optimal cooking results.

In one embodiment, the plurality of temperature probe inputs includes: (a) a chamber temperature probe input, and (b) a food internal temperature probe input. The smoker cooker cooling fan power supply output further has a first relay to provide multiple phase control to the smoker cooker cooling fan power supply output. The smoke generator control output further includes a second relay to provide multiple phase control to the smoke generator power supply output. The multiple phase controls are synchronized with the cooking phases of the smoke cooker.

In one embodiment, the plurality of information displays includes: (a) an LED Smoke Generator output indicator R indicating whether the Smoke generator is powered on (LED on) or off (LED off), (b) an LED Smoker Cooker output indicator OUT indicating whether the smoker cooker is powered on (LED on) or off (LED off), (c) a TEMP1 display window indicating the chamber temperature received from the chamber temperature probe input, and (d) a TEMP2/TIME display window indicating the food internal temperature received from the food internal temperature probe input, or the cooking time after the programmable temperature controller is powered up (cooking time) if an LED indicator TIME is lit.

In one embodiment, the plurality of user input keys includes: (a) a “SET” key for displaying current temperature settings, getting into parameter setting mode and confirming various actions taken, (b) a “−” key for decrement of displayed value when the programmable temperature controller is in parameter setting mode, and during normal operation, for cancelling any alarm when it is pressed, (c) a “+” key for increment of displayed value when the programmable temperature controller is in parameter setting mode, and during normal operation, for displaying current phase number the smoker cooker is current in when it is pressed, and (d) a “TIME” key for toggling the TEMP2/TIME display window display between the food internal temperature received from the food internal temperature probe input when the LED indicator TIME is off, and the cooking time after the programmable temperature controller is powered up (cooking time) when the LED indicator TIME is lit.

The cooking and smoking food with the smoker cooker and the smoke generator, both controlled by the programmable temperature controller with dual temperature probes accommodates following cooking phases: (a) drying, (b) smoking, (c) cooking, (d) finishing cooking, and (e) cooling. Each of these cooking phases can be terminated by following ending criteria: (a) a predetermined cooking time, or (b) a predetermined food internal temperature. The cooking process is programmed into the programmable temperature controller by the user.

In one embodiment, the programming step includes following steps: (a) setting parameters of the cooking process, and (b) setting parameters of the first relay for controlling the smoker cooker cooling fan power supply output and the second relay for controlling the smoke generator power supply output.

In one embodiment, the setting the cooking process step includes:
(a) initializing the phase number to 1;
(b) setting the smoker cooker chamber temperature for the phase;
(c) selecting the ending criteria: T for cooking time, or F for food internal temperature;
(d) if T is selected, entering the cooking time T in minutes, and if F is selected, entering the food internal temperature in Fahrenheit;
(e) asking user whether to program the next phase;
(f) if the answer is yes, increase the phase number by 1 and go back to step (b); and
(g) if the answer is no, terminate the setting the cooking process step.

In one embodiment, the step of setting parameters of the first relay for controlling the smoker cooker cooling fan power supply output and the second relay for controlling the smoke generator power supply output includes:
(a) initializing the relay number N to 1;
(b) initializing the phase number PHASE to 1;
(c) setting the parameter of the relay number N, to 0 to turn this cooking PHASE off and 1 to turn this cooking PHASE on;
(d) asking user whether to set the parameter of the next PHASE;
(e) if the answer is yes, increase the PHASE number by 1 and go back to step (c);
(f) if the answer is no, asking user whether to set the parameter of next relay;
(g) if the answer is yes, increase the relay number by 1 and go back to step (b); and
(h) if the answer is no, terminate step of setting parameters of the first relay and the second relay.

In one embodiment, the step of monitoring the cooking and smoking process includes:
(a) monitoring the current smoker cooker chamber temperature through the TEMP1 display window;
(b) monitoring the current food internal temperature through the TEMP2/TIME display window;
(c) monitoring time passed since the programmable temperature controller was powered on by pressing the “TIME” key once and when the LED indicator TIME is on;
(d) monitoring the current cooking phase through the TEMP1 display window by pressing the “+” key once;
(e) monitoring whether the smoke generator is powered on through the LED Smoke Generator output indicator R;
(f) monitoring whether the smoker cooker is powered on through the LED Smoker Cooker output indicator OUT, and
(g) when the LED Smoke Generator output indicator R, and the LED Smoker Cooker output indicator OUT are both turned off and the current phase reached the last phase as programmed, the cooking and smoking process is completed.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a block diagram of a programmable temperature controller with dual temperature probes for cooking and smoking of food according to one embodiment of the present invention;

FIG. 2 is a front view of the programmable temperature controller with dual temperature probes for cooking and smoking of food according to one embodiment of the present invention;

FIG. 3 is a rear view of the programmable temperature controller with dual temperature probes for cooking and smoking of food according to one embodiment of the present invention;

FIG. 4 is a flow chart of user programming of a cooking process of the programmable temperature controller with dual temperature probes for cooking and smoking of food according to one embodiment of the present invention;

FIG. 5 is an exemplary program setting of a cooking process of the programmable temperature controller with dual temperature probes for cooking and smoking of food according to one embodiment of the present invention;

FIG. 6 is a flow chart of user setting of parameters of a first relay for controlling the smoker cooker cooling fan power supply output and a second relay for controlling smoke generator power supply output of the programmable temperature controller with dual temperature probes for cooking and smoking of food according to one embodiment of the present invention;

FIG. 7 is an exemplary setting of parameters of the first relay for controlling the smoker cooker cooling fan power supply output and the second relay for controlling smoke generator power supply output of the programmable temperature controller with dual temperature probes for cooking and smoking of food according to one embodiment of the present invention;

FIG. 8 shows a list of system configuration parameters, their range and initial set value when left the factory according to one embodiment of the present invention;

FIG. 9 shows how the system configuration parameters are set according to one embodiment of the present invention;

FIG. 10 shows a list of control performance parameters, their range and initial set value when left the factory according to one embodiment of the present invention;

FIG. 11 shows how the control performance parameters are set according to one embodiment of the present invention;

FIG. 12 shows a list of alarm parameters, their range and initial set value when left the factory according to one embodiment of the present invention; and

FIG. 13 shows how the alarm parameters are set according to one embodiment of the present invention.

### DETAILED DESCRIPTION OF THE PRESENT INVENTION

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

Embodiments of the present invention are described below with reference to the accompanying drawings, and in the accompanying drawings like reference numerals represent like elements.

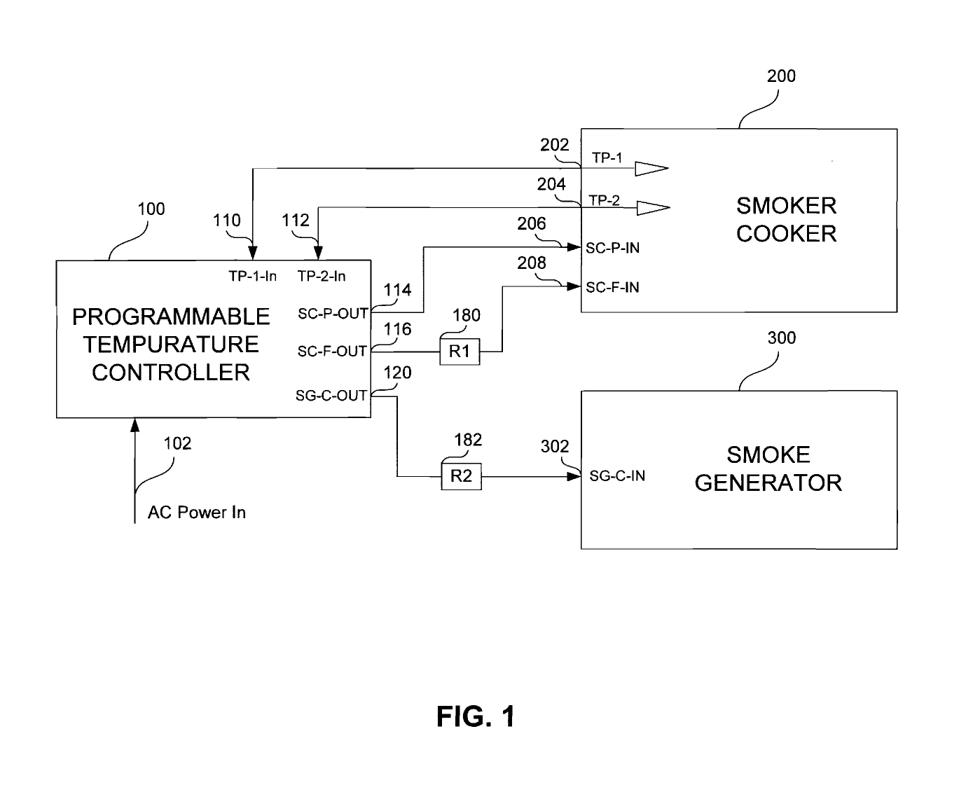

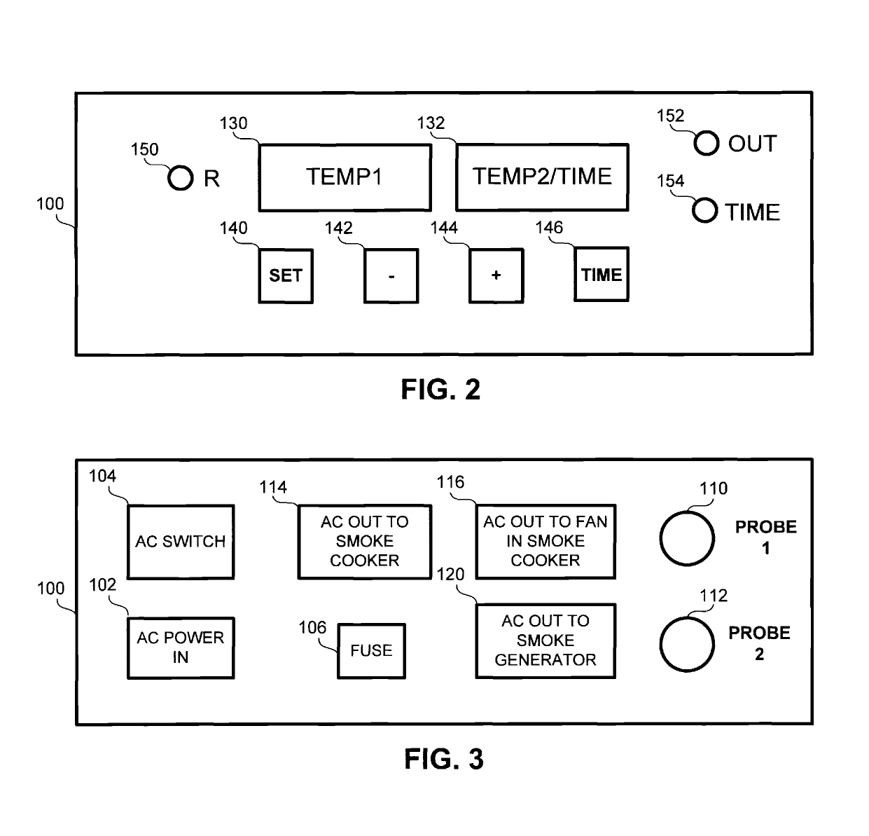

In FIG. 1, a block diagram of a temperature controlled cooking and smoking system is shown according to one embodiment of the present invention. The temperature controlled cooking and smoking system has a smoker cooker 200, a smoke generator 300. The smoker cooker 200 and the smoke generator 300 are controlled by a programmable temperature controller 100 with dual temperature probes 202 and 204. FIG. 2 shows a front view of the programmable temperature controller 100 and FIG. 3 shows a rear view of the programmable temperature controller 100 according to one embodiment of the present invention.

Referring now to FIGS. 1-3, in one embodiment, the programmable temperature controller 100 has:
(a) an AC power supply 102 with a switch 104 and a fuse 106 for providing power supply to the programmable temperature controller 100, a Smoker Cooker 200, and a Smoke Generator 300;
(b) a plurality of temperature probe inputs 110 and 112;
(c) a smoker cooker power supply output SC-P-OUT 114 for providing and controlling the power supply to the smoker cooker 200;
(d) a smoker cooker cooling fan power supply output SC-F-OUT 116 for providing and controlling the power supply to a cooling fan for the smoker cooker 200;
(e) a smoke generator control output SG-C-OUT 120 for providing and controlling the power supply to the smoke generator 300;
(f) a plurality of user input keys for a user to enter cooking control parameters according to a plurality of cooking phases;
(g) a plurality of information displays for displaying cooking process and progress, current temperatures, cooking durations, status of the smoker cooker 200 and the smoke generator 300, and
(h) a central processing unit with internal memory to store a plurality of control programs from the user, and controls the food cooking and smoking process according to the programs.

The user uses the plurality of user input keys 140, 142, 144, and 146 to program the programmable temperature controller 100. The programmable temperature controller 100 controls the smoker cooker 200, and the smoke generator 300 according to the plurality of the temperature probe inputs and cooking duration programmed into the programmable temperature controller 100 to obtain optimal cooking results. In one embodiment, a general purpose micro-computer system is used as the central processing unit.

In one embodiment, the plurality of temperature probe inputs includes: (a) a smoker cooker chamber temperature probe input 110, and (b) a smoker cooker food internal temperature probe input 112. The smoker cooker cooling fan power supply output 116 further includes a first relay R1 180 to provide multiple phase control to the smoker cooker cooling fan. The smoke generator power supply output 120 further includes a second relay R2 182 to provide multiple phase control to the smoke generator. The multiple phase controls are synchronized with the cooking phases of the smoke cooker.

The plurality of information displays includes:
(a) an LED Smoke Generator output indicator R 150 indicating whether the Smoke Generator 300 is powered on (LED on) or off (LED off);
(b) an LED Smoker Cooker output indicator OUT 152 indicating whether the smoker cooker 200 is powered on (LED on) or off (LED off);
(c) a TEMP1 display window 130 indicating the chamber temperature received from the chamber temperature probe input 110; and
(d) a TEMP2/TIME display window 132 indicating the food internal temperature received from the food internal temperature probe input 112, or the cooking time after the programmable temperature controller 100 is powered up (cooking time) if an LED indicator TIME 154 is on.

The plurality of user input keys includes:
(a) a “SET” key 140 for displaying current temperature settings, getting into parameter setting mode and confirming various actions taken;
(b) a “−” key 142 for decrement of displayed value when the programmable temperature controller 100 is in parameter setting mode, and during normal operation, for cancelling any alarm when it is pressed;
(c) a “+” key 144 for increment of displayed value when the programmable temperature controller 100 is in parameter setting mode, and during normal operation, for displaying current phase number the smoker cooker 200 is current in when it is pressed; and
(d) a “TIME” key 146 for toggling the TEMP2/TIME display window 132 display between the food internal temperature received from the food internal temperature probe input 112 when the LED indicator TIME 154 is off, and the cooking time after the programmable temperature controller 100 is powered up (cooking time) when the LED indicator TIME 154 is on.

In one embodiment, the smoker cooker 200 has: (a) a smoker cooker chamber temperature probe TP-1 202, (b) a smoker cooker food internal temperature probe TP-2, (c) a smoker cooker power input SC-P-IN 206, and (d) a smoker cooker cooling fan power input SC-F-IN 208. In one embodiment, the smoker cooker chamber temperature probe TP-1 202 is connected to the smoker cooker chamber temperature probe input 110 of the programmable temperature controller 100, and the smoker cooker chamber temperature probe TP-2 204 is connected to the smoker cooker food internal temperature probe input 112 of the programmable temperature controller 100. The smoker cooker power input SC-P-IN 206 is connected to the smoker cooker power supply output SC-P-OUT 114 of the programmable temperature controller 100, and the smoker cooker power input SC-F-IN 208 is connected to the smoker cooker power supply output SC-F-OUT 116 of the programmable temperature controller 100. The smoke generator 300 has a power input SG-C-IN 302. This power input receives the electrical power to operate and control the smoke generator 300 from a smoke generator control output SG-C-OUT 120 of the programmable temperature controller 100 through the second relay R2 182.

The programmable temperature controller 100 allows the user to cook and smoke the food with following cooking phases:
(a) drying;
(b) smoking;
(c) cooking;
(d) finishing cooking; and
(e) cooling.

The programmable temperature controller 100 also allows the user to terminate each of these cooking phases by following ending criteria:
(a) a predetermined cooking time; and
(b) a predetermined food internal temperature.

Each of the cooking phases can be terminated independently to allow user the maximum flexibility to cook and smoke the food and obtain the best results. The cooking process is programmed into the programmable temperature controller 100 by the user.

In another aspect, the present invention related to a method of cooking and smoking food with a smoker cooker 200 and a smoke generator 300, both controlled by a programmable temperature controller 100 with dual temperature probes according to one embodiment of the present invention. In one embodiment, the method includes the steps of:
(a) providing a programmable temperature controller 100:
(b) programming the programmable temperature controller 100 by a user by using a plurality of user input keys 140, 142, 144, and 146;
(c) turning on the programmable temperature controller 100, the smoker cooker 200 and the smoke generator 300 to cook and smoke the food;
(d) monitoring the cooking and smoking process through a plurality of information displays 130, 132, 150, 152, and 154;
(e) retrieving the food when the plurality of information displays indicate that the cooking and smoking process is completed, and
(f) turning off the programmable temperature controller 100, the smoker cooker 200 and the smoke generator 300, when the cooking and smoking process is completed.

In one embodiment, the programmable temperature controller 100 has:
(a) an AC power supply 102 with a switch 104 and a fuse 106 for providing power supply to the programmable temperature controller 100, a smoker cooker 200, and a smoke generator 300;
(b) a plurality of temperature probe inputs 110 and 112;
(c) a smoker cooker power supply output SC-P-OUT 114 for providing and controlling the power supply to the smoker cooker 200;
(d) a smoker cooker cooling fan power supply output SC-F-OUT 116 for providing and controlling the power supply to a cooling fan for the smoker cooker 200;
(e) a smoke generator control output SG-C-OUT 120 for providing and controlling the power supply to the smoke generator 300;
(f) a plurality of user input keys for a user to enter cooking control parameters according to a plurality of cooking phases;
(g) a plurality of information displays for displaying cooking process and progress, current temperatures, cooking durations, status of the smoker cooker 200 and the smoke generator 300, and
(h) a central processing unit with internal memory to store a plurality of control programs from the user, and controls the food cooking and smoking process according to the programs.

In one embodiment, the plurality of temperature probe inputs includes: (a) a smoker cooker chamber temperature probe input 110, and (b) a smoker cooker food internal temperature probe input 112. The smoker cooker cooling fan power supply output 116 further includes a first relay R1 180 to provide multiple phase control to the cooling fan of the smoker cooker 200. The smoke generator power supply output 120 further includes a second relay R2 182 to provide multiple phase control to the smoke generator 300.

The plurality of information displays includes:
(a) an LED Smoke Generator output indicator R 150 indicating whether the Smoke Generator 300 is powered on (LED on) or off (LED off);
(b) an LED Smoker Cooker output indicator OUT 152 indicating whether the smoker cooker 200 is powered on (LED on) or off (LED off);
(c) a TEMP1 display window 130 indicating the chamber temperature received from the chamber temperature probe input 110; and
(d) a TEMP2/TIME display window 132 indicating the food internal temperature received from the food internal temperature probe input 112, or the cooking time after the programmable temperature controller 100 is powered up (cooking time) if an LED indicator TIME 154 is on.

The plurality of user input keys includes:
(a) a “SET” key 140 for displaying current temperature settings, getting into parameter setting mode and confirming various actions taken;
(b) a “−” key 142 for decrement of displayed value when the programmable temperature controller 100 is in parameter setting mode, and during normal operation, for cancelling any alarm when it is pressed;
(c) a “+” key 144 for increment of displayed value when the programmable temperature controller 100 is in parameter setting mode, and during normal operation, for displaying current phase number the smoker cooker 200 is current in when it is pressed; and
(d) a “TIME” key 146 for toggling the TEMP2/TIME display window 132 display between the food internal temperature received from the food internal temperature probe input 112 when the LED indicator TIME 154 is off, and the cooking time after the programmable temperature controller 100 is powered up (cooking time) when the LED indicator TIME 154 is on.

The programming step for the programmable temperature controller 100 includes at least following steps:
(a) setting parameters of a cooking process; and
(b) setting parameters of the first relay R1 180 for controlling the smoker cooker cooling fan power supply output and the second relay R2 182 for controlling smoke generator power supply output.

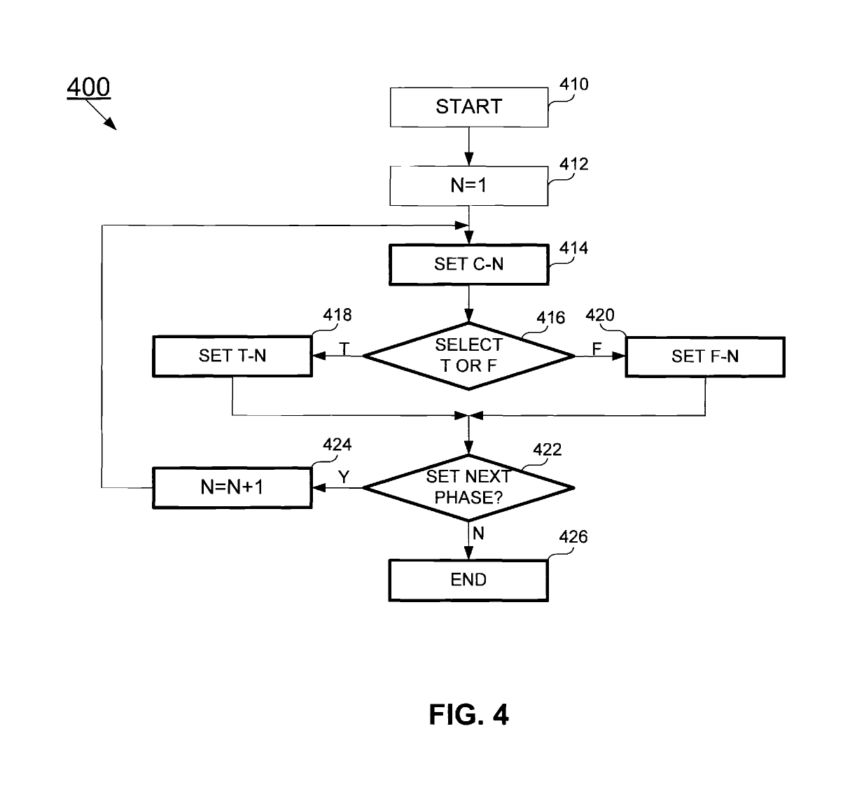

Referring now to FIG. 4, a flow chart of user programming of the cooking process of the programmable temperature controller 100 with dual temperature probes for cooking and smoking of food is shown according to one embodiment of the present invention. The setting parameters of the cooking process includes the steps of:
(a) initializing the phase number to 1, as shown in step 412, after the first start step 410;
(b) setting the smoker cooker chamber temperature for the phase, as shown in step 414;
(c) selecting the ending criteria, as shown in step 416: T for cooking time, or F for food internal temperature;
(d) if T is selected, entering the cooking time T in minutes, as shown in step 418, and if F is selected, as shown in step 420, entering the food internal temperature in Fahrenheit;
(e) asking user whether to program the next phase, as shown in step 422;
(f) if the answer is yes, increase the phase number by 1 and go back to step (b), as shown in step 424; and
(g) if the answer is no, terminate the setting the cooking process step, as shown in step 426.

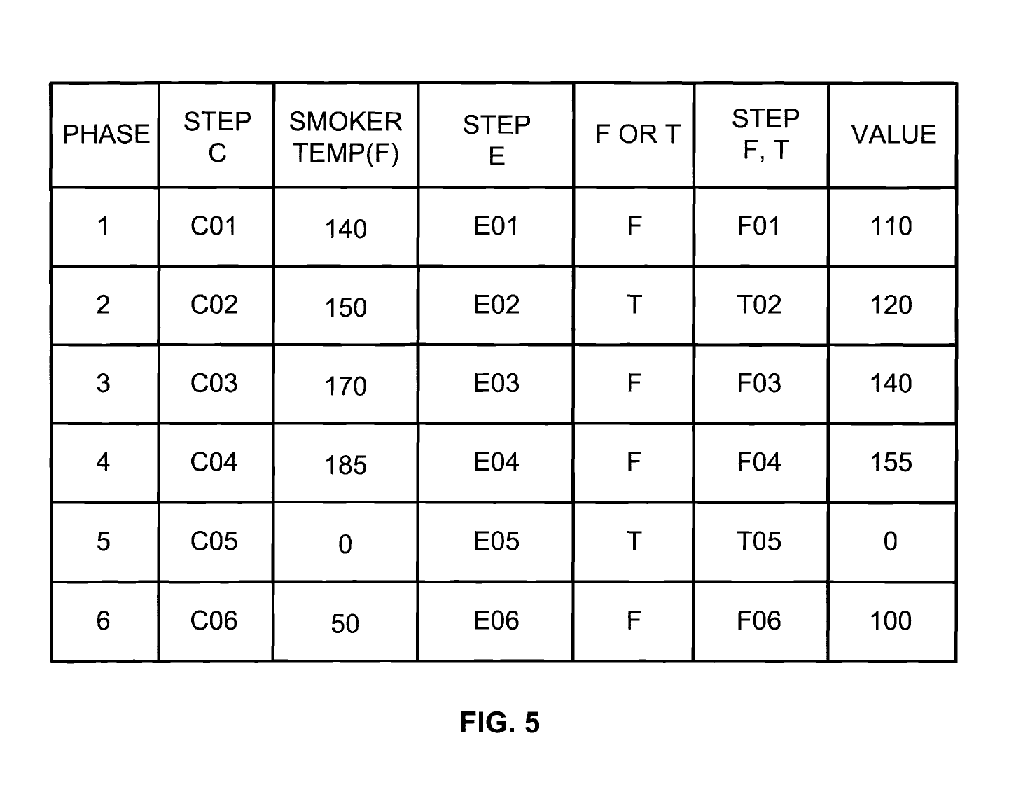

FIG. 5 is an exemplary program setting of a cooking process of the programmable temperature controller with dual temperature probes for cooking and smoking of food according to one embodiment of the present invention.

According to the parameters set in FIG. 5, the cooking process programmed includes:

Phase 1: Drying Phase:
Start the smoker cooker at a smoker cooker chamber temperature at 140° F., the phase will be terminated with the food internal temperature reach to a predetermined value. In this example, this phase is terminated when the food internal temperature reaches 110° F.;

Phase 2: Cooking Phase
The smoker cooker chamber temperature is increased to 150° F., the phase will be terminated with a predetermined time interval. In this example, this phase is terminated when the smoker cooker cooks the food for 120 minutes (2 hours);

Phase 3: Smoking Phase
The smoker cooker chamber temperature is further increased to 170° F., the phase will be terminated with the food internal temperature reach to a predetermined value. In this example, this phase is terminated when the food internal temperature reaches 140° F.;

Phase 4: Finishing Cooking Phase
The smoker cooker chamber temperature is further increased to 180, the phase will be terminated with the food internal temperature reach to a predetermined value. In this example, this phase is terminated when the food internal temperature reaches 155° F.;

Phase 5: None
The smoker cooker chamber temperature is set to 0, the phase will be skipped.

Phase 6: Cooling Phase
The smoker cooker chamber temperature is further decreased to 50° F., the phase will be terminated with the food internal temperature reach to a predetermined value. In this example, this phase is terminated when the food internal temperature reaches 100° F.

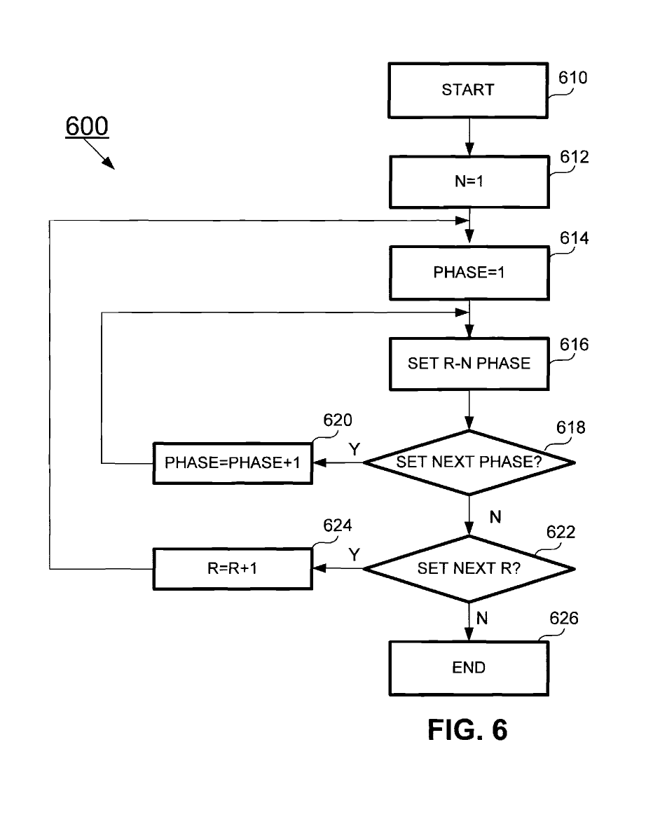

FIG. 6 is a flow chart of user setting of parameters of the first relay R1 180 for controlling the smoker cooker cooling fan power supply output 116 and the second relay R2 182 for controlling smoke generator power supply output 120 of the programmable temperature controller 100 with dual temperature probes for cooking and smoking of food according to one embodiment of the present invention. The setting parameters of the first relay R1 180 for controlling the smoker cooker cooling fan power supply output 116 and the second relay R2 182 for controlling smoke generator power supply output 120 step includes:
(a) initializing the relay number N to 1, as shown in step 612, after the start step 610;
(b) initializing the phase number PHASE to 1, as shown in step 614;
(c) setting the parameter of the relay number N, as shown in step 616, to 0 to turn this cooking PHASE off and 1 to turn this cooking PHASE on;
(d) asking user whether to set the parameter of the next PHASE, as shown in step 618;
(e) if the answer is yes, increase the PHASE number by 1 and go back to step (c) or step 616, as shown in step 620;
(f) if the answer is no, asking user whether to set the parameter of next relay, as shown in step 622;
(g) if the answer is yes, increase the relay number by 1 and go back to step (b) or step 624; and
(h) if the answer is no, terminate step of setting parameters of the first relay and the second relay, as shown in step 626.

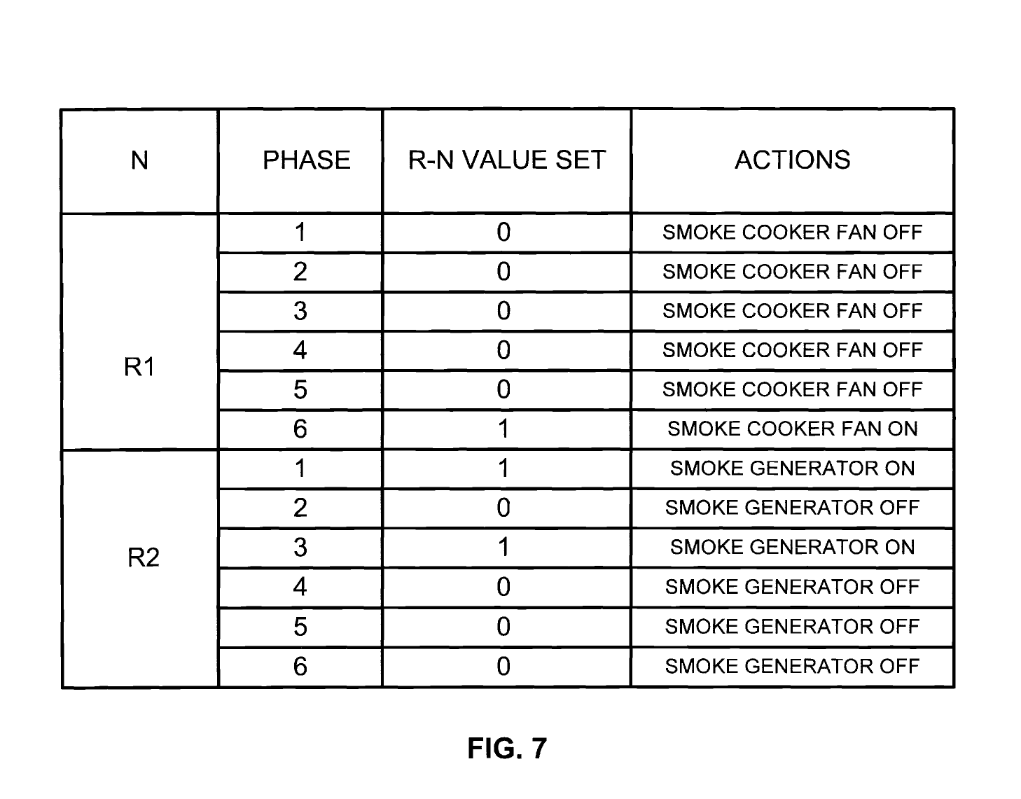

FIG. 7 shows an exemplary setting of parameters of the first relay R1 180 for controlling the smoker cooker cooling fan power supply output 116 and the second relay R2 182 for controlling smoke generator power supply output 120 of the programmable temperature controller 100 with dual temperature probes for cooking and smoking of food according to one embodiment of the present invention,

According to the parameters set in FIG. 7, the smoking process includes:
(a) The phase number 6 for the Relay R1 180 is set to 1, which means that the smoker cooker cooling fan power supply output 116 is to be turned on during Phase 6 (Cooling Phase);
(b) The phase numbers 1 and 3 for the Relay R2 182 are set to 1, which means the power supply output 120 of the Smoke Generator 200 is to be turned on during first phase (Drying Phase) and the third phase (Smoking Phase).

Additional Relays can be added to accommodate the users recipe.

The step of monitoring the cooking and smoking process includes:
(a) monitoring the current smoker cooker chamber temperature through the TEMP1 display window 130;
(b) monitoring the current food internal temperature through the TEMP2/TIME display window 132;
(c) monitoring time passed since the programmable temperature controller was powered on by pressing the “TIME” key 146 once and when the LED indicator TIME 154 is on;
(d) monitoring the current cooking phase through the TEMP1 display window 130 by pressing the “+” key once;
(e) monitoring whether the smoke generator 300 is powered on through the LED Smoke Generator output indicator R 150;
(f) monitoring whether the smoker cooker 200 is powered on through the LED Smoker Cooker output indicator OUT 152, and
(g) when the LED Smoke Generator output indicator R 150, and the LED Smoker Cooker output indicator OUT 152 are both turned off and the current phase reached the last phase as programmed, the cooking and smoking process is completed.

In order to achieve maximum precision temperature control, a proportional integral derivative (PID) controller is used as the core of the programmable temperature controller 100. The PID controller requires some additional parameters to be set properly to function. These parameters are divided into three groups:
(a) control performance parameters
(b) system configuration parameters:
(c) alarm parameters:

To prevent changing critical parameters by accident, an access lock, LCK is used. Special code is needed to open the lock for these parameters. To set the control performance parameters, a passcode 166 is used. To set the system configuration parameters, a passcode 155 is used. To set the alarm parameters, a passcode 188 is used.

The control performance parameters need to be adjusted based on the system to be controlled. The control performance parameters:
(a) P—Proportional band. The base unit is 0.1 degree. This parameter control the output of the controller based on the difference between the measured temperature and the set temperature. Larger the P number means the weaker the action (lower gain), e.g. If P=100, the proportional band is 10 degree (100×0.1=10). When the sensor temperature is 10 degrees below the proportional band (10 degrees below the setting), the controller will have 100% output. When the temperature is 5 degree below the set point, the output is 50%. When the temperature is equal to the setting, the controller will have 0% output (assuming integral and derivative functions are turned off). This constant also affects both integral and derivative action. Smaller P values will make the both integral and derivative action stronger. Please note the value of the P is temperature unit sensitive. If you found an optimized P value when operating the controller in Fahrenheit, you need to divide the P by 1.8 when changing the temperature unit to Celsius.
(b) I—Integral time. The unit is in seconds. This parameter controls the output of controller based on the difference between the measured and set temperature integrated with time. Integral action is used to eliminate temperature offset. Larger number means slower action. e.g. assuming the difference between the measured and set temperature is 2 degrees and remain unchanged, the output will increase continuously with time until it reaches 100%. When temperature fluctuate regularly (system oscillating), increase the integral time. Decrease it if the controller is taking too long to eliminate the temperature offset. When 1=0, the system becomes a PD controller. For very slow response system such as slow cooker and large commercial rice cooker, set I=0 will significantly reduce the temperature overshoot.
(c) D—Derivative time. The unit is in seconds. Derivative action contributes the output power based on the rate of temperature change. Derivative action can be used to minimize the temperature overshoot by responding its rate of change. The larger the number is, the faster the action will be, e.g. when the door of oven is opened, the temperature will drop at very high rate. The derivative action change the controller output based on the rate of change rather than the net amount of change. This will allow the controller to act sooner. It will turn the heater to full power before the temperature drops too much.
(d) AT—Auto-tune function. Set AT to 1 then exit the menu. The display will start to flash alternately between AT and current water bath temperature, which indicates auto-tuning is in progress. When the display stops flashing, the auto-tuning is finished. Now, the newly calculated PID parameters are set and are used for the system. The new parameters will store in the memory even the power is off
(e) T—cycle rate. The unit is second. This unit determines how long for the controller to calculate each action. e.g. If T is set to 10 seconds, when controller decide the output should be 10%, it will turn on the heater 1 second for every 10 seconds. This parameter should set at 2 second for heating with an electric heater.

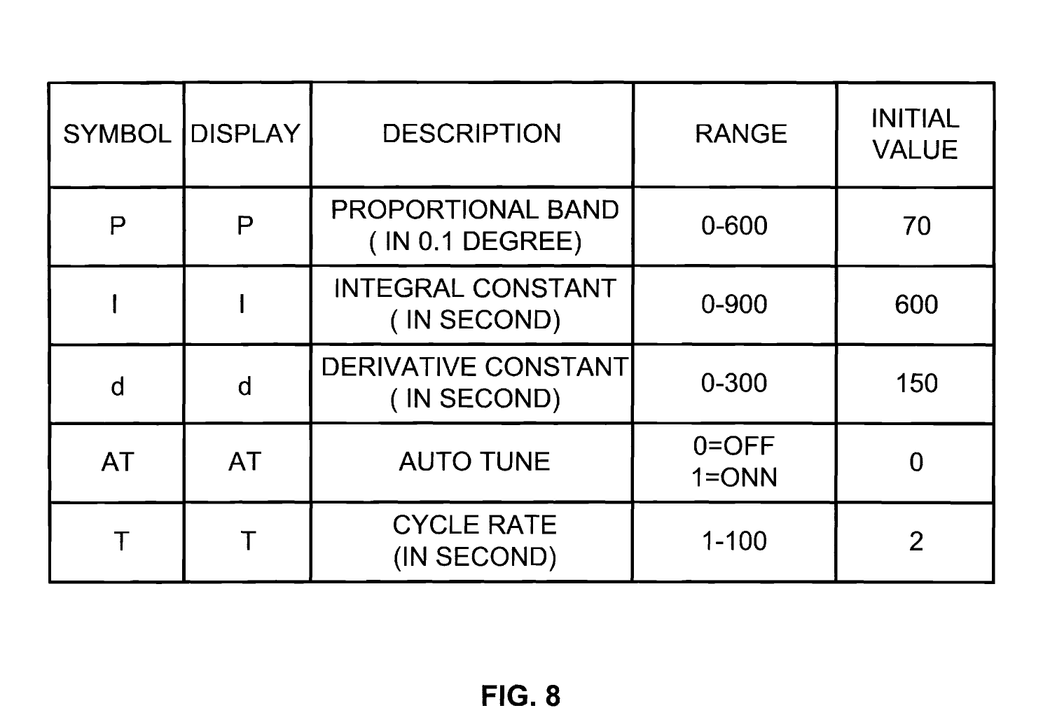

FIG. 8 shows the list of these control performance parameters, their range and initial set value when left the factory. Once the system configuration parameters are set, they normally do not need to be changed. The control performance parameters setting can be accessed by code 166.

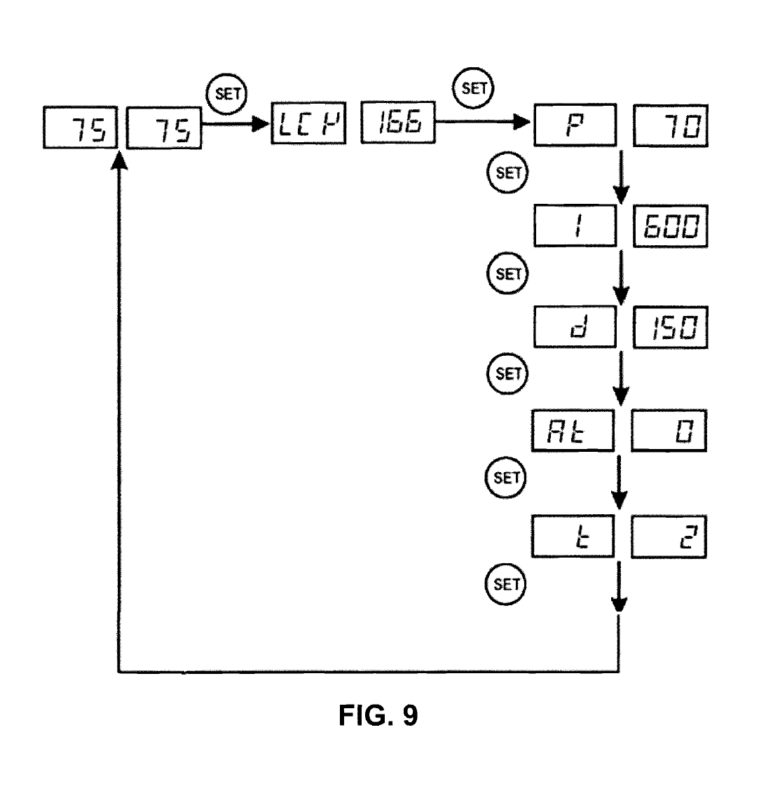

FIG. 9 shows how these control performance parameters are set. The user presses and holds the “SET” key for 4 seconds until LED display “LCK” on the left TEMP1 display window, then releases the “SET” key. A “0” is displayed on the right TEMP2/TIME window. To get into parameters setting mode, a proper passcode is to be keyed in. Use “+” and “−” keys to adjust the display to 166 (which is the pass code to set the control performance parameters) and press SET. The left TEMP1 window will display “P” and right window is P setting value, use “+” and “−” keys to change the setting to desired value. When finished, press the SET again to confirm the change. The left display will show the “I” right window has its setting value, use the same “P” setting procedure to set the I value. The rest of parameters are set in the same way.

Once system configuration parameters are set, they normally do not need to be changed. The system configuration parameters includes:
SC—calibration offset. The parameter is used to make the input offset to compensate the error produced by sensor, e.g. if the temperature displays of left window is 2.0° C. in ice water mixture, set SC1=−2.0 will make the display to shown 0.0 degree. SC1 is for the Smoker Cooker chamber temperature probe. SC2 is for the food internal temperature probe.
OUT—Output power reduction. It is expressed as a percentage value. This function will allow you to control the maximum output power delivered by the heater. For example, if you set Out=50 and your heater is 1000 watts, the output will use 50% of the 1000 watts as the full output. It uses the 1000 watts heater as a 500 watts heater.
When the PID algorithm determines 50% output value, the actual power output will be 250 watts. This function can be used in two situations.
   (a) When you have a very powerful heater and using a very small pot of water to cook at very low temperature, for example, a 1400 watts heater with a one litter (1 qt) pot of water at 130° F. The heater is too powerful for the small water volume. The moment it is on, it releases too much energy to cause the temperature to overshoot. Although it is still possible to stabilize the temperature with proper PID parameters, it is much easier to control if you limit the maximum output to 25%. Ideally, an optimized temperature control system should consume about 25% of the heater power at set temperature (steady state), for example, if you found out that only 50 watts of energy is needed to maintain the temperature at 60° C. (141° F.), ideally you should use only 200 watts heater for the job. Too much power will make the system over react too quickly. Too little power will make the system too slow in response. By using the Out function, you can make the 1400 watts heater to act as a 200 watt heater for stable temperature control.
   (b) When the cooker consumes more power than controller can handle, for example, if you have a 12 A, 120V AC heater and your cooker contains more than 38 liter (10 gallon) of water. It might take more than 90 minutes of full power heating for controller to heat up the pot. Long time of full power operation might cause the controller to over heat. You can set the output to 80%. It will prevent the controller from over heat by staying a full power too long.
C-F—Display unit setting. The temperature display can be set to either Celsius or Fahrenheit.

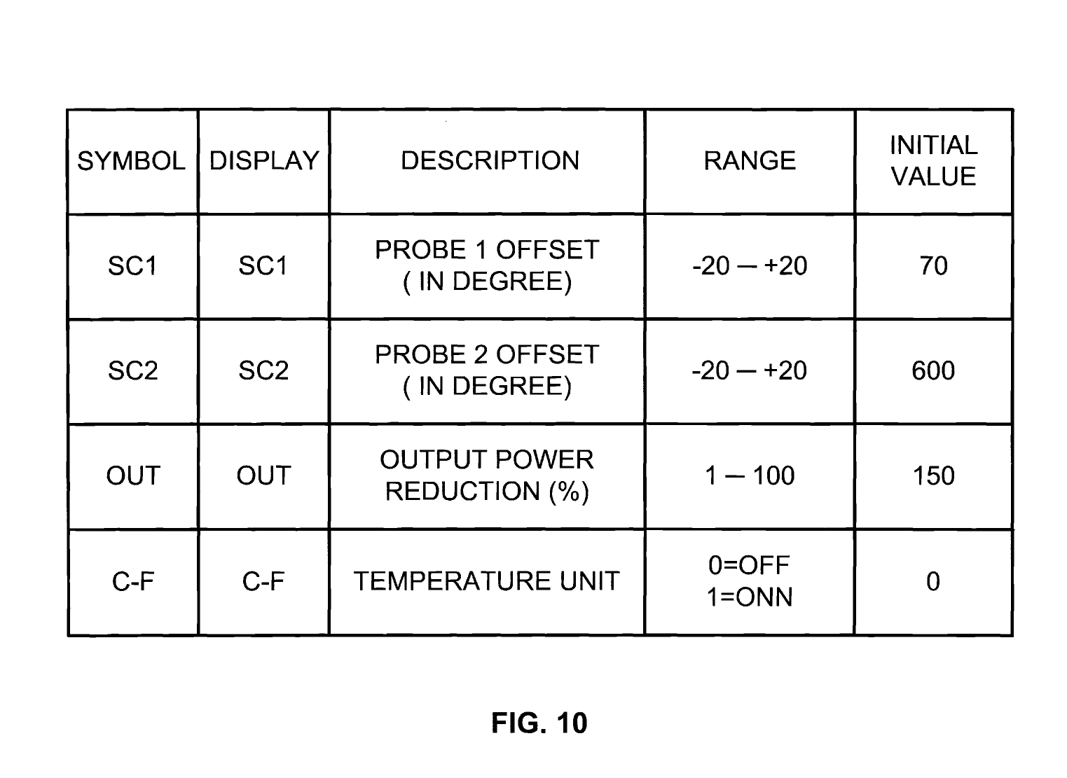

FIG. 10 shows the list of these system configuration parameters, their range and initial set value when left the factory. The system configuration parameters setting can be accessed by code 155.

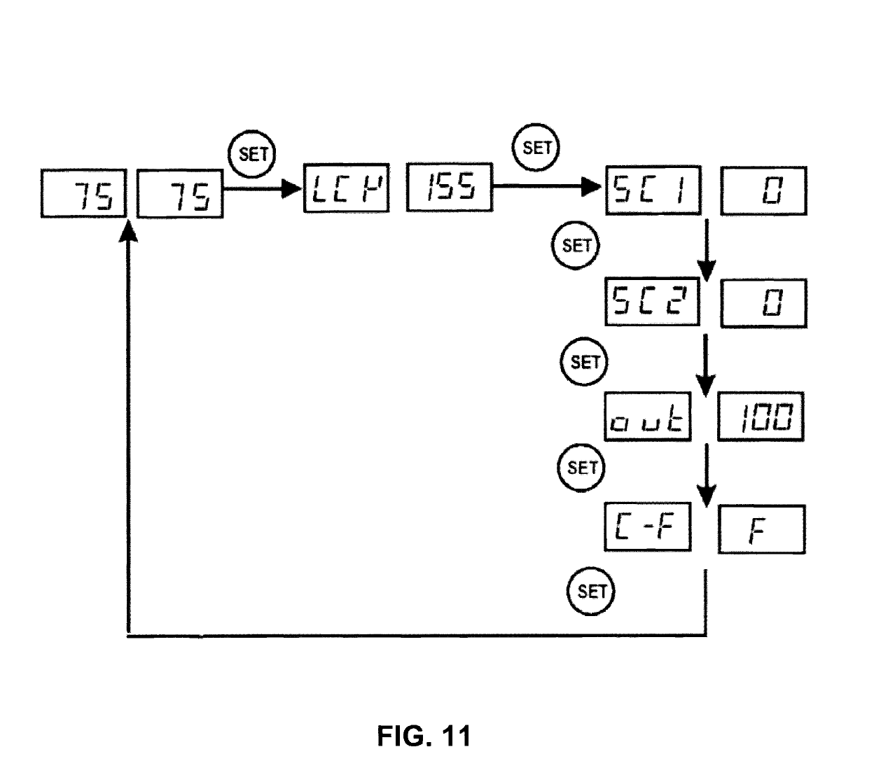

FIG. 11 shows how these system configuration parameters are set. The user presses and holds “SET” key for 4 second until left window displayed “LCK”, and then releases the “SET” key. A “0” will be displayed on the right TEMP2/TIME window. The user uses “+” and “−” keys to adjust the display to 155 (the pass code for setting the system configuration parameters) and press SET. The left TEMP1 window will show the parameter to be set and right TEMP2/TIME window will show its corresponding value. Use “+” and “−” keys to change the setting. When finished, press the SET, to confirm the change. The next parameter will be displayed and set in a similar fashion until the system configuration parameters are set.

The system configuration parameters includes:
AH1, this is the high limit alarm for the smoker cooker chamber temperature probe 1. User can set the temperature so that if the smoker cooker chamber temperature goes beyond this high limit, a buzzer will sound to alert the user the situation, e.g. if AH1 set to 290, the buzzer will be on at 291 and off at 290. When the buzzer is on, the left window will flashing between AH1 and the current temperature.
AL1 is the low limit alarm for probe 1. e.g. If AL1 is set to 100. The buzzer will be on when temperature drop to 100. It will be turned of when temperature rise to 101. This alarm is suppressed when first powered up. It will only function after the temperature has reached set point once. When the buzzer is on, the left window will flashing between AL1 and the current temperature.
AH2 is the high limit alarm for the food internal temperature probe 2. If AH2 set to 190, the buzzer will sound at 191 and be turned off at 190. When the buzzer is on, the right TEMP2/TIME window will flashing between AH2 and the current temperature. When smoking multiple piece of meat with different thickness, user can put the probe in the thinnest piece first. Set the alarm to the temperature when meat is ready. It will let you know when it is done. Then, you can move the probe to the second thinnest pieces and so on. To use this feature, you can set the ending criteria to time. If you set ending criteria to temperature, you need to set the ending temperature to be higher than the alarm temperature.
AST is the step ending alarm. When AST is turned on, the buzzer will beep 4 times when each step is finished. It is useful to notify the user the cooking step is finished. User can turn it off if no buzzer sound is wanted at the finish of each step.

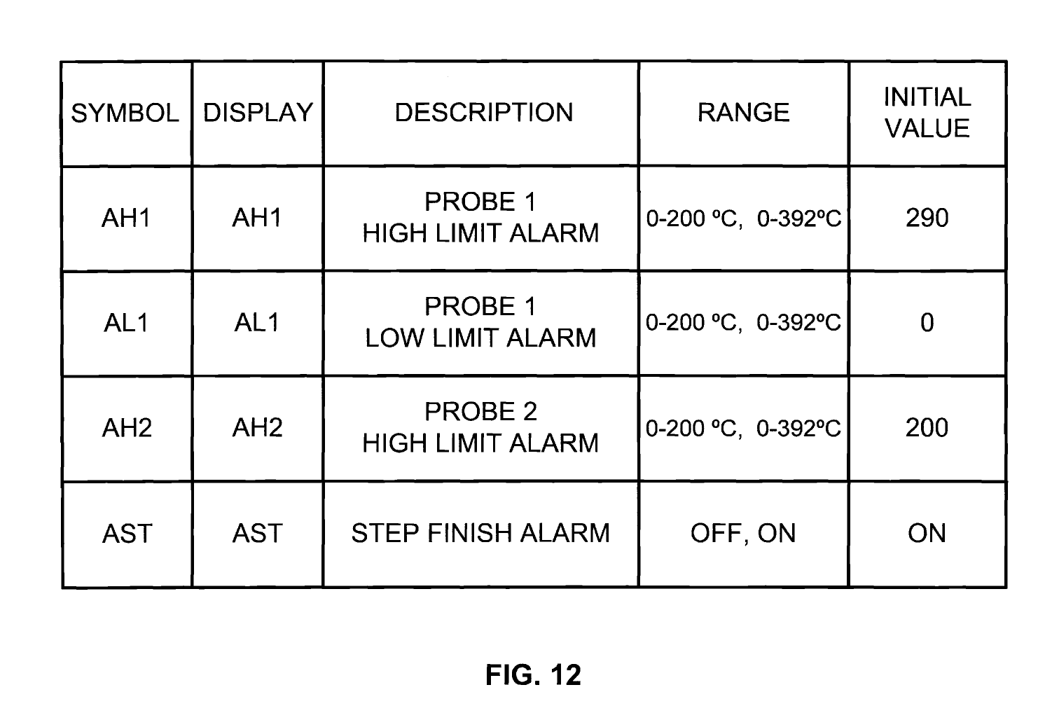

FIG. 12 shows the list of the parameters, their range and initial set value when left the factory. The alarm setting can be accessed by code 188.

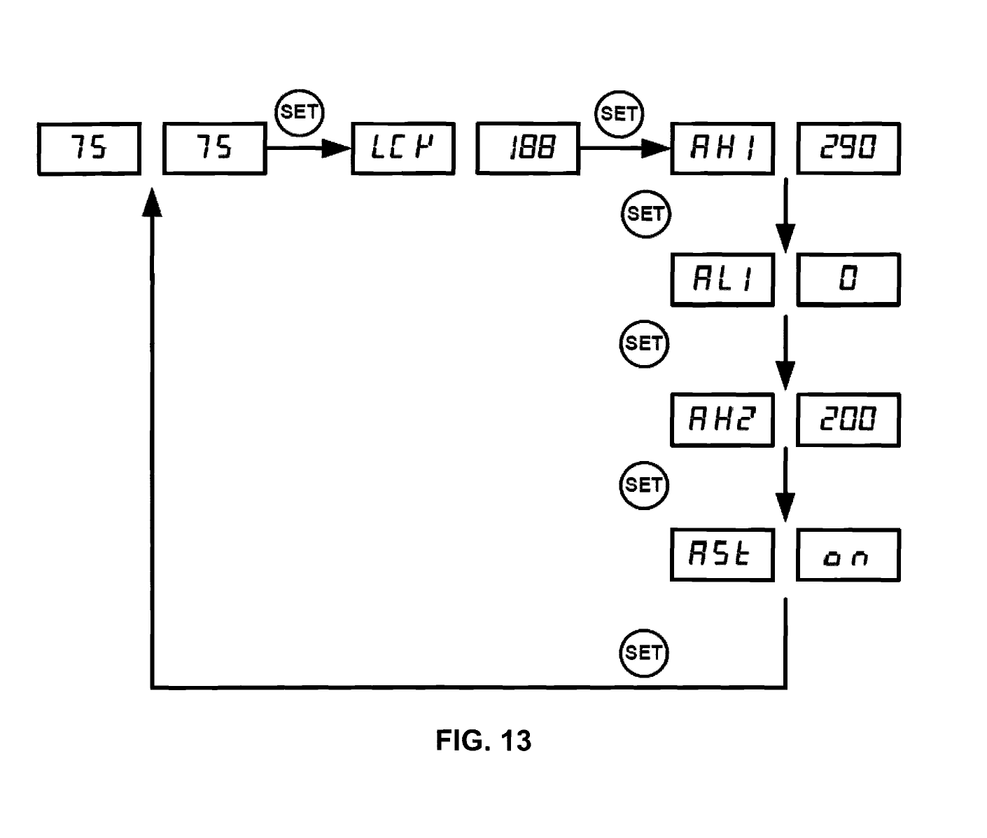

FIG. 13 shows how these alarm parameters are set. The user presses and holds the “SET” key for 4 second until left TEMP1 window displayed “LCK” and releases the “SET” key. A “0” will be displayed on the right TEMP2/TIME window. The user uses “+” key and “−” key to adjust the display to 188 (the pass code for setting alarms) and presses the “SET” key. The left TEMP1 window will show the parameter and right TEMP2/TIME window will show its corresponding value. Use “+” and “−” keys to change the setting. When finished, press the SET, to confirm the change. The next parameter will be displayed and set in a similar fashion until the alarm parameters are set.

All alarms can be cancelled during beeping by pressing the “−” key.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A programmable temperature controller with dual temperature probes for cooking and smoking of food, comprising:
(a) an AC power supply with a switch and a fuse for providing power supply to the programmable temperature controller, a smoker cooker, and a smoke generator;
(b) a plurality of temperature probe inputs;
(c) a smoker cooker power supply output for providing and controlling the power supply to the smoker cooker;
(d) a smoker cooker cooling fan power supply output for providing and controlling the power supply to a cooling fan for the smoker cooker;
(e) a smoke generator control output for providing and controlling the power supply to the smoke generator;
(f) a plurality of user input keys for a user to enter cooking control parameters according to a plurality of cooking phases;
(g) a plurality of information displays for displaying cooking process and progress, current temperatures, cooking durations, status of the smoker cooker and the smoke generator, and
(h) a central processing unit with internal memory to store a plurality of control programs from the user, and controls the food cooking and smoking process according to the programs,
wherein the user uses the plurality of user input keys to program the programmable temperature controller, the programmable temperature controller controls the smoker cooker, and the smoke generator according to the plurality of the temperature probe inputs and cooking duration programmed into the programmable temperature controller to obtain optimal cooking results.

2. The programmable temperature controller according to claim 1, wherein the plurality of temperature probe inputs comprises:
(a) a smoker cooker chamber temperature probe input; and
(b) a smoker cooker food internal temperature probe input.

3. The programmable temperature controller according to claim 2, wherein the smoker cooker cooling fan power supply output further comprises a first relay to provide multiple phase control to the smoker cooker cooling fan, where the multiple phase controls are synchronized with the cooking phases of the smoke cooker, and wherein the smoke generator control output further comprises a second relay to provide multiple phase control to the smoke generator, where the multiple phase controls are synchronized with the cooking phases of the smoke cooker.

4. The programmable temperature controller according to claim 3, wherein the plurality of information displays comprises:
(a) an LED Smoke Generator output indicator R indicating whether the Smoke generator is powered on (LED on) or off (LED off);
(b) an LED Smoker Cooker output indicator OUT indicating whether the smoker cooker is powered on (LED on) or off (LED off);
(c) a TEMP1 display window indicating the chamber temperature received from the chamber temperature probe input; and
(d) a TEMP2/TIME display window indicating the food internal temperature received from the food internal temperature probe input, or the cooking time after the programmable temperature controller is powered up (cooking time) if an LED indicator TIME is lit.

5. The programmable temperature controller according to claim 4, wherein the plurality of user input keys comprises:
(a) a “SET” key for displaying current temperature settings, getting into parameter setting mode and confirming various actions taken;
(b) a “−” key for decrement of displayed value when the programmable temperature controller is in parameter setting mode, and during normal operation, for cancelling any alarm when it is pressed;
(c) a “+” key for increment of displayed value when the programmable temperature controller is in parameter setting mode, and during normal operation, for displaying current phase number the smoker cooker is current in when it is pressed; and
(d) a “TIME” key for toggling the TEMP2/TIME display window display between the food internal temperature received from the food internal temperature probe input when the LED indicator TIME is off, and the cooking time after the programmable temperature controller is powered up (cooking time) when the LED indicator TIME is lit.

6. The programmable temperature controller according to claim 5, wherein the plurality of cooking phases comprises:
(a) drying;
(b) smoking;
(c) cooking;
(d) finishing cooking; and
(e) cooling

7. The programmable temperature controller according to claim 6, wherein each of the plurality of cooking phases can be terminated by following ending criteria:
(a) a predetermined cooking time; and
(b) a predetermined food internal temperature,
wherein the cooking process is programmed into the programmable temperature controller by the user.

8. A method of cooking and smoking food with a smoker cooker and a smoke generator, both controlled by a programmable temperature controller with dual temperature probes, comprising:
(a) providing a programmable temperature controller:
(b) programming the programmable temperature controller by using a plurality of user input keys;
(c) turning on the programmable temperature controller, the smoker cooker and the smoke generator to cook and smoke the food;
(d) monitoring the cooking and smoking process through a plurality of information displays;
(e) retrieving the food when the plurality of information displays indicate that the cooking and smoking process is completed, and
(f) turning off the programmable temperature controller, the smoker cooker and the smoke generator.

9. The method according to claim 8, wherein the programmable temperature controller comprises:
(a) an AC power supply with a switch and a fuse for providing the power supply to the programmable temperature controller, the smoker cooker, and the smoke generator;
(b) a plurality of temperature probe inputs;
(c) a smoker cooker power supply output for providing and controlling the power supply to the smoker cooker;
(d) a smoker cooker cooling fan power supply output for providing and controlling the power supply to a cooling fan for the smoker cooker;
(e) a smoke generator control output for providing and controlling the power supply to the smoke generator;
(f) a plurality of user input keys for a user to enter cooking control parameters according to a plurality of cooking phases;
(g) a plurality of information displays for displaying cooking process and progress, current temperatures, cooking durations, status of the smoker cooker and the smoke generator; and
(h) a central processing unit with internal memory to store a plurality of control programs from the user, and controls the food cooking and smoking process according to the programs,
wherein the user uses the plurality of user input keys to program the programmable temperature controller, the programmable temperature controller controls the smoker cooker, and the smoke generator according to the plurality of the temperature probe inputs and cooking duration programmed into the programmable temperature controller to obtain optimal cooking results;

10. The method according to claim 9, wherein the plurality of temperature probe inputs comprises
(a) a chamber temperature probe input; and
(b) a food internal temperature probe input.

11. The method according to claim 10, wherein the smoker cooker cooling fan power supply output further comprises a first relay to provide multiple phase control to the smoker cooker cooling fan, where the multiple phase controls are synchronized with the cooking phases of the smoke cooker, and wherein the smoke generator control output further comprises a second relay to provide multiple phase control to the smoke generator, where the multiple phase controls are synchronized with the cooking phases of the smoke cooker.

12. The method according to claim 11, wherein the plurality of information displays comprises:
(a) an LED Smoke Generator output indicator R indicating whether the Smoke generator is powered on (LED on) or off (LED off);
(b) an LED Smoker Cooker output indicator OUT indicating whether the smoker cooker is powered on (LED on) or off (LED off);
(c) a TEMP1 display window indicating the chamber temperature received from the chamber temperature probe input; and
(d) a TEMP2/TIME display window indicating the food internal temperature received from the food internal temperature probe input, or the cooking time after the programmable temperature controller is powered up (cooking time) if an LED indicator TIME is lit.

13. The method according to claim 12, wherein the plurality of user input keys comprises:
(a) a “SET” key for displaying current temperature settings, getting into parameter setting mode and confirming various actions taken;
(b) a “−” key for decrement of displayed value when the programmable temperature controller is in parameter setting mode, and during normal operation, for cancelling any alarm when it is pressed;
(c) a “+” key for increment of displayed value when the programmable temperature controller is in parameter setting mode, and during normal operation, for displaying current phase number the smoker cooker is in when it is pressed; and
(d) a “TIME” key for toggling the TEMP2/TIME display window display between the food internal temperature received from the food internal temperature probe input when the LED indicator TIME is off, and the cooking time after the programmable temperature controller is powered up (cooking time) when the LED indicator TIME is lit.

14. The method according to claim 13, wherein the plurality of cooking phases comprises:
(a) drying;
(b) smoking;
(c) cooking;
(d) finishing cooking; and
(e) cooling.

15. The method according to claim 14, wherein each of the plurality of cooking phases can be terminated by following ending criteria:
(a) a predetermined cooking time; and
(b) a predetermined food internal temperature,
wherein the cooking process is programmed into the programmable temperature controller by the user.

16. The method according to claim 15, wherein the programming step further comprises:
(a) setting parameters of the cooking process; and
(b) setting parameters of the first relay for controlling the smoker cooker cooling fan power supply output and the second relay for controlling smoke generator power supply output.

17. The method according to claim 16, wherein the setting the cooking process step further comprises:
(a) initializing the phase number to 1;
(b) setting the smoker cooker chamber temperature for the phase;
(c) selecting the ending criteria: T for cooking time, or F for food internal temperature;
(d) if T is selected, entering the cooking time T in minutes, and if F is selected, entering the food internal temperature in Fahrenheit;
(e) asking user whether to program the next phase;
(f) if the answer is yes, increase the phase number by 1 and go back to step (b); and
(g) if the answer is no, terminate the setting the cooking process step.

18. The method according to claim 17, wherein the step of setting parameters of the first relay for controlling the smoker cooker cooling fan power supply output and the second relay for controlling smoke generator power supply output further comprises:
(a) initializing the relay number N to 1;
(b) initializing the phase number PHASE to 1;
(c) setting the parameter of the relay number N, to 0 to turn this cooking PHASE off and 1 to turn this cooking PHASE on;
(d) asking user whether to set the parameter of the next PHASE;
(e) if the answer is yes, increase the PHASE number by 1 and go back to step (c);
(f) if the answer is no, asking user whether to set the parameter of next relay;
(g) if the answer is yes, increase the relay number by 1 and go back to step (b); and
(h) if the answer is no, terminate step of setting parameters of the first relay and the second relay.

19. The method according to claim 18, wherein the step of monitoring the cooking and smoking process further comprises:
(a) monitoring the current smoker cooker chamber temperature through the TEMP1 display window;
(b) monitoring the current food internal temperature through the TEMP2/TIME display window;
(c) monitoring time passed since the programmable temperature controller was powered on by pressing the “TIME” key once and when the LED indicator TIME is on;
(d) monitoring the current cooking phase through the TEMP1 display window by pressing the “+” key once;
(e) monitoring whether the smoke generator is powered on through the LED Smoke Generator output indicator R;
(f) monitoring whether the smoker cooker is powered on through the LED Smoker Cooker output indicator OUT, and
(g) when the LED Smoke Generator output indicator R, and the LED Smoker Cooker output indicator OUT are both turned off and the current phase reached the last phase as programmed, the cooking and smoking process is completed.
